(19) United States
(12) Patent Application Publication
(10) Pub. No.: US 2017/0063916 A1
(43) Pub. Date: Mar. 2, 2017

(54) SYSTEM AND METHOD FOR AUTOMATICALLY IDENTIFYING BROKEN AUTHENTICATION AND OTHER RELATED VULNERABILITIES IN WEB SERVICES

(71) Applicant: Wegilant Net Solutions Private Limited, Gurgaon (IN)

(72) Inventors: Toshendra Kumar Sharma, Mumbai (IN); Bhanu Prakash Valluri, Gurgaon (IN)

(21) Appl. No.: 14/880,629

(22) Filed: Oct. 12, 2015

(30) Foreign Application Priority Data
Aug. 26, 2015 (IN) 2658/DEL/2015

(51) Int. Cl. H04L 29/06

(52) U.S. Cl. CPC H04L 63/1433

(57) ABSTRACT

A system for automatically identifying broken authentication and other related vulnerabilities in web services are disclosed. The system includes an emulating module, a first database, a second database, a tampering module and a response analysis module. The emulating module is configured to run web service with (a) a first credential, and (b) a second credential to obtain first and second parameters. The first database and the second database is configured to store (i) the first session identifying parameters, (ii) the first request, and, (iii) the first response, (iv) the second session identifying parameters, (v) the second request, and (vi) the second response. The tampering module is configured to receive (a) the first and the second request from the first and the second database. The response analysis module is configured to receive (a) the third response from the tampering module.

### CROSS-REFERENCE TO RELATED APPLICATIONS

This application claims priority to Indian patent application no. 2658/DEL/2015 filed on Aug. 26, 2015, the complete disclosure of which, in its entirely, is herein incorporated by reference.

### BACKGROUND

Technical Field

The embodiments herein generally relate to a vulnerability assessment system, and more particularly, to an automated system for identifying broken authentication and other related vulnerabilities in web services.

Description of the Related Art

Web services that are vulnerable and not compliant with organizational policy present great risks to an organization, including the threats of network intrusion and data disclosure. Authentication and session management is critical to web services security. Flaws in this area most frequently involve failure to protect credentials and session tokens. These flaws can lead to the hijacking of user or administrative accounts, undermine authorization and accountability controls, and cause privacy violations. Authentication relies on secure communication and credential storage. When developers are programming web services based solutions they rarely focus on how the user's session is managed and thus introducing session management vulnerabilities in the web services.

Session management vulnerabilities occur when developers fail to protect the user sensitive information such as user names, passwords, and session tokens. Broken authentication vulnerabilities occur when developers fail to use authentication methods that have been adequately tested.

These vulnerabilities are very hard for developers to identify on their own due to the far-reaching aspect of the code that handles session and authentication. Due to the broad reach of this vulnerability there are many examples of broken authentication and session management occurring. For Example forgotten password functionality, emailing user credentials, relying on IP address for session, not authenticating a user before changing a password, and not having adequate timeouts for inactive sessions. Web services often have a forgotten password functionality that allows a user to submit their user name to the application and are taken to a page with secret questions or a temporary password reset function. Attackers can exploit this functionality to enumerate valid user name for the web service. Developers often forget that a user name is half the puzzle to an attacker.

Accordingly, there remains a need for an improved system to automatically test\assess a web services for vulnerabilities.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

In one aspect, an automatic vulnerability assessment system to assess vulnerability of a web service is disclosed. The automatic vulnerability assessment system to assess vulnerability of a web service includes a memory unit that stores a set of modules and a processor that executes the set of modules. The set of modules includes an emulating module, a first database, a second database, a tampering module and a response analysis module. The emulating module is configured to run the web service with (a) a first credential to obtain first parameters, and (b) a second credential to obtain second parameters. In an embodiment, the first parameters include (i) a first session identifying parameters, (ii) a first request, and, (iii) a first response. The second parameters include (i) a second session identifying parameters, (ii) a second request, and, (iii) a second response. The first database is configured to store (i) the first session identifying parameters, (ii) the first request, and, (iii) the first response. The second database is configured to store (i) the second session identifying parameters, (ii) the second request, and (iii) the second response. The tampering module is configured to receive (a) the first request from the first database, and (b) the second request from the second database. The tampering module is configured to tamper one or more parameters of the first request with parameter values of the second request to obtain a third response. The response analysis module is configured to receive (a) the third response from the tampering module, (b) the first response from the first database, and (c) the second response from the second database.

In an embodiment, the response analysis module assesses vulnerability of the web service by comparing the third response with the second response. In an embodiment, the response analysis module determines vulnerabilities of high severity of the web service when the third response includes a part of the second response and medium severity of the web service when the third response is not an error. In an embodiment, the tampering module tampers a plurality of parameters of the second request with parameter values of the first request to obtain a fourth response. In an embodiment, the response analysis module assesses vulnerability of the web service by comparing the fourth response with the first response. The response analysis module determines vulnerabilities of high severity of the web service when the fourth response includes a part of the first response. The response analysis module determines vulnerabilities of medium severity of the web service when the fourth response is not an error.

In another aspect, a method of automatically assessing vulnerability of a web service is disclosed. The method of automatically assessing vulnerability of a web service includes the following steps: (i) running a web service in an emulating module with (a) a first credential to obtain first parameters, and (b) a second credential to obtain second parameters, (ii) storing, at first database, (a) the first session identifying parameters, (b) the first request, and, (c) the first response, (iii) storing (a) the second session identifying parameters, (b) the second request, and (c) the second response, (iv) receiving, using a tampering module, (a) the first request from the first database, and (b) the second request from the second database, (v) tampering a plurality of parameters of the first request with parameter values of the second request to obtain a third response, (vi) receiving (a) the third response from the tampering module, (b) the first response from the first database, and (c) the second response from the second database, (vii) comparing the third response with the second response to assess vulnerability of the web service, (viii) determining vulnerabilities of high severity of the web service when the third response includes a part of the second response, and (ix) determining vulnerabilities of medium severity of the web service when the third response is not an error.

In yet another aspect, a non-transitory program storage device readable by computer, and comprising a program of instructions executable by said computer to perform a method for automatically assessing vulnerability of a web service is disclosed and the method includes the following steps: (i) running, a web service with (a) a first credential to obtain first parameters, and (b) a second credential to obtain second parameters, (ii) storing (a) the first session identifying parameters, (b) the first request, and, (c) the first response, (iii) storing, at second database, (a) the second session identifying parameters, (b) the second request, and (c) the second response, (iv) receiving (a) the first request and (b) the second request, (v) tampering a plurality of parameters of the first request with parameter values of the second request to obtain a third response, (vi) receiving (a) the third response from the tampering module, (b) the first response and (c) the second response (vii) comparing the third response with the second response to assess vulnerability of the web service, (viii) identifying vulnerabilities of high severity of the web service when the third response includes a part of the second response, and (ix) identifying vulnerabilities of medium severity of the web service when the third response is not an error.

### BRIEF DESCRIPTION OF THE DRAWINGS

The embodiments herein will be better understood from the following detailed description with reference to the drawings, in which:

FIG. 1 illustrates a system view of a user device interacting with a web service through a network for assessing vulnerabilities using a vulnerability assessment system according to an embodiment herein;

FIG. 2 illustrates an exploded view of the vulnerability assessment system of FIG. 1 according to an embodiment herein;

FIG. 3 is a flow diagram illustrating a method of automatically assessing vulnerabilities on a web service using the vulnerability assessment system of FIG. 1 according to an embodiment herein; and

FIG. 4 illustrates a schematic diagram of a computer architecture used according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

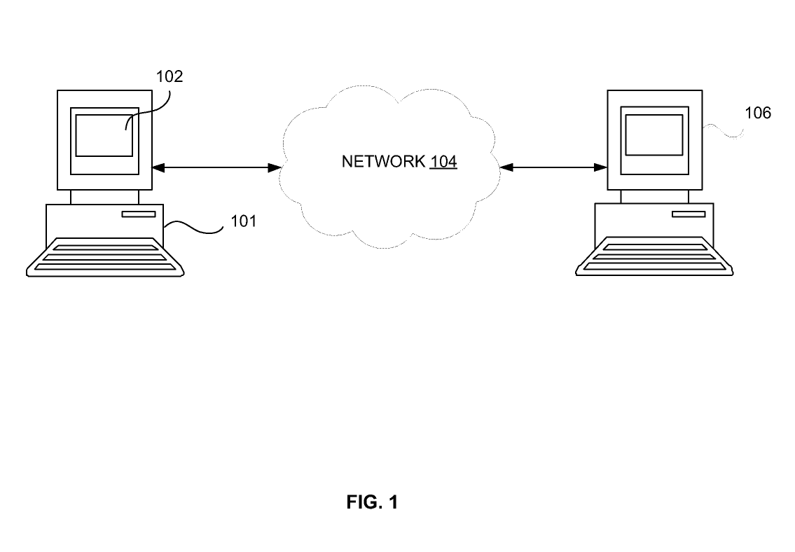

As mentioned, there remains a need for an improved system to automatically test\assess a web service for vulnerabilities. The embodiments herein achieve this by providing a vulnerability assessment system that automatically identifies/assesses vulnerabilities on a web service based on credentials. Referring now to the drawings, and more particularly to FIGS. 1 through 4, where similar reference characters denote corresponding features consistently throughout the figures, there are shown preferred embodiments.

FIG. 1 illustrates a system view of a user device 101 which has a vulnerability assessment system 102 is configured to a web service 106 through a network 104 for assessing vulnerabilities according to one embodiment herein. In an embodiment, the vulnerability assessment system 102 detects a broken authentication on the web service 106. The network 104 may include a wired network, a wireless network, a mobile communication network, a ZigBee, and the like. In an embodiment, the user devices 101 may be smart devices, smart phones, tablet PC's, laptops, personal computers, and/or an ultra-books, and the like.

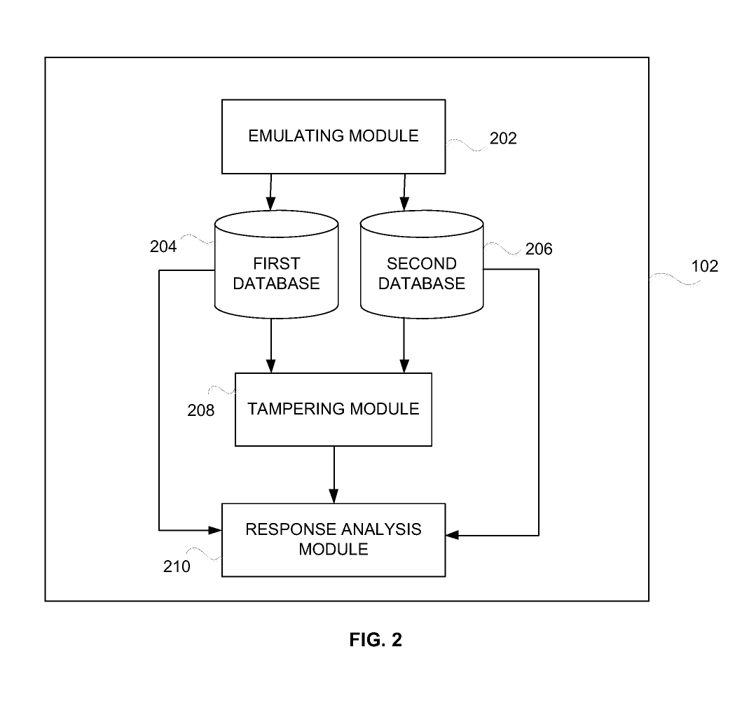

FIG. 2 illustrates an exploded view of the vulnerability assessment system 102 of FIG. 1 according to an embodiment herein. The vulnerability assessment system 102 includes an emulating module 202, a first database 204, a second database 206, a tampering module 208, and a response analysis module 210. The emulating module 202 is configured to run the web service 106. In one embodiment, the emulating module 202 is configured to run a first credential and results obtained by running the web service using the first credential is a first parameter. The first parameter includes (a) a first identifying parameters, (b) a first request, and (c) a first response is stored in a first database 204. In another embodiment, the emulating module 202 is configured to run a second credential and results obtained by running the web service using the second credential is a second parameter. The second parameter includes (a) a second identifying parameters, (b) a second request, and (c) a second response is stored in a second database 206. The first credential and the second credential have similar access privileges. In an embodiment, the first request, the second request, the first response, and the second response may be an http (hypertext transfer protocol) requests and responses. The first request and the second request include headers, body and is complaint with RFC 2616. The RFC 2616 is known to one skilled in the art. A routine implementation of a pseudo http code for http request is shown below:

POST /path/script.cgi HTTP/1.0
From: Priya@abc.co
User-Agent: HTTPTool/1.0
Content-Type: application/x-www-form-urlencoded
Content-Length: 32
height=175&age=27&id=9&token=jh984bkasd89qbkasd8wd787e987qwhbd78we

A pseudo http code for obtaining an http response is shown below:

HTTP/1.1 200 OK
Server: Apache/1.3.3.7 (Unix) (Red-Hat/Linux)
Content-Type: text/html; charset=UTF-8Content-Length: 138
Accept-Ranges: bytes
Connection: close

The tampering module 208 is configured to receive a first request from the first database 204 and a second request from the second database 206. In one embodiment, the parameters of the first request are tampered to contain parameter values from second request to obtain a third response.

A pseudo code for first request is shown below:
“height=175&age=27&id=9&token=unahjh984bkasd89qbkasd8wd787e987qwhbd78we”
A pseudo code for tampering http body by sending the second request is shown below:
“height=175&age=27&id=10&token=karpjh653bkasd34qbkasd6wd712e987qwhbd87we”

In another embodiment, the third response from the tampering module 208 is fed to the response analysing module 210. The response analysis module 210 determines if a valid response is received for an invalid request. In yet another embodiment, the response analysing module 210 contains the first response from the first database 204 and the second response from the second database 206 respectively.

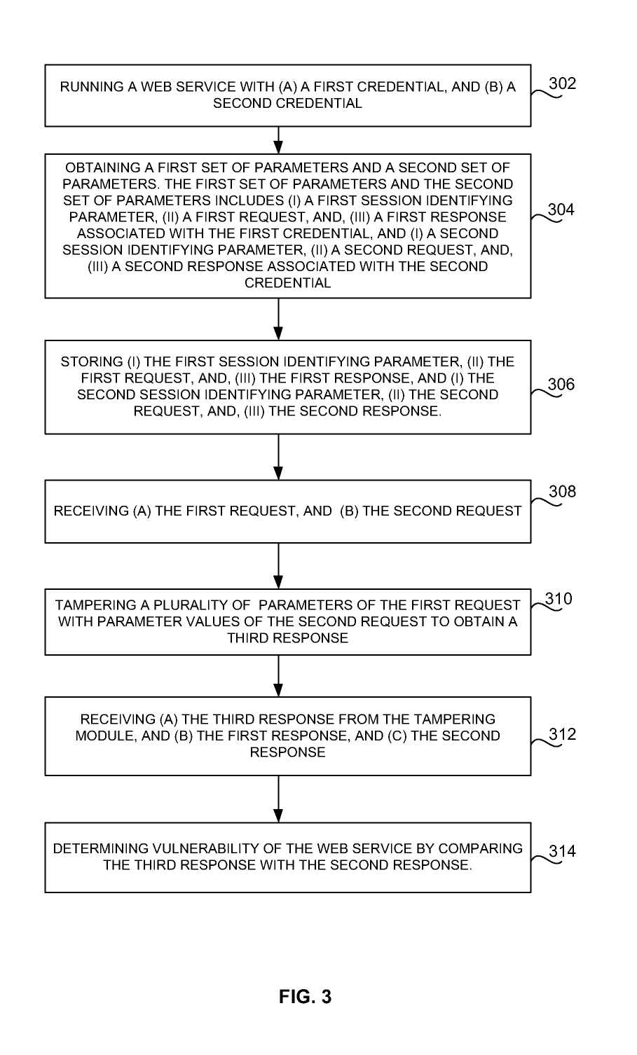

FIG. 3 is a flow diagram illustrating a method of automatically assessing vulnerabilities on a web service using the vulnerability assessment system of FIG. 1 according to an embodiment herein. At step, 302, running a web service with (a) a first credential to obtain first parameters. At step, 304, obtaining a first set of parameters and second set of parameters and the first and second set of parameters includes (i) a first session identifying parameter, (ii) a first request, and, (iii) a first response associated with the first credential, and (i) a second session identifying parameter, (ii) a second request, and, (iii) a second response associated with the second credential. At step, 306, storing (i) the first session identifying parameter, (ii) the first request, and, (iii) the first response, and (i) the second session identifying parameter, (ii) the second request, and, (iii) the second response. At step, 308, receiving (a) the first request (for example from the first database 204), and (b) the second request (for example from the second database 206). At step, 310, tampering a plurality of parameters of the first request with parameter values of the second request to obtain a third response. At step, 312, receiving (a) the third response and (b) the first response, and (c) the second response (for example from the first database 204 and the second database 206). At step, 314, determining vulnerability of the web service by comparing the third response with the second response. In one embodiment, the third response is compared with the second response to check if the third response is response of the first request with tampered parameters. For example comparison may be a simple file diff command (any utility that highlights the differences in two files). The result of the difference is analyzed to find out if there are parts of the second response in the third response. In an embodiment, the comparison is performed by a utility such as diff utility, cmp, comm, diff-text, diff3, tkdiff, spiff and the like. For example diff command is used to display line-by-line difference between two files.

A routine implementation of a diff command is shown below:
diff FILE1 FILE2
Where, FILE1 FILE2: Diff command will examine both file1 and file2 and tells you what changes need to be made for file1 and file2 to match. Please note that diff command point to which lines need be:

Added (a)
Deleted (d)
Changed (c)
Further lines in file1 identified with a less than (<) symbol and lines in
file2 with a greater than (>) symbol.
For Example
diff file1.txt file2.txt
Output:
8c8,9
URL: www.abc.co
> Email: support@abc.co
The contents of both files:
$ cat file1.txt
Output:
Welcome to abc!
If undelivered return to abc
#804, 11^{th} main,
Gurgaon
Ph: 0124 4848600
URL: www.abc.co
$ cat file2.txt
Output:
Welcome to abc!
If undelivered return to abc
#804, 11^{th} main,
Gurgaon
Ph: 0124 4848600
URL: www.abc.co
Email: support@abc.co
$ sdiff file1.txt file2.txt
Output:

| | |
|---|---|
| Welcome to abc! | Welcome to abc! |
| If undelivered return to abc | If undelivered return to abc |
| # 804, 11^{th} main, | # 804, 11^{th} main, |
| Gurgaon | Gurgaon |
| Ph: 0124 4848600 | Ph: 0124 4848600 |
| URL: www.abc.com | \| URL: www.abc.in |
| | > Email: support@abc.in |

In another embodiment, vulnerabilities of high severity of the web service 106 are identified when the third response is a part of the second response. In yet another embodiment, vulnerabilities of medium severity of the web service 106 are identified when the third response is not an error. In yet another embodiment, a plurality of parameters of the second request is tampered with parameter values of the first request to obtain a fourth response and vulnerability of the web service 106 is assesses by comparing the fourth response with the first response. In yet another embodiment, vulnerabilities of high severity of the web service 106 are identified when the fourth response comprises a part of the first response and vulnerabilities of medium severity of the web service 106 are identified when the fourth response is not an error. In yet another embodiment, processing of the tampering module 208 and the response analysis module 210 is repeated with all the possible combinations of tampering.

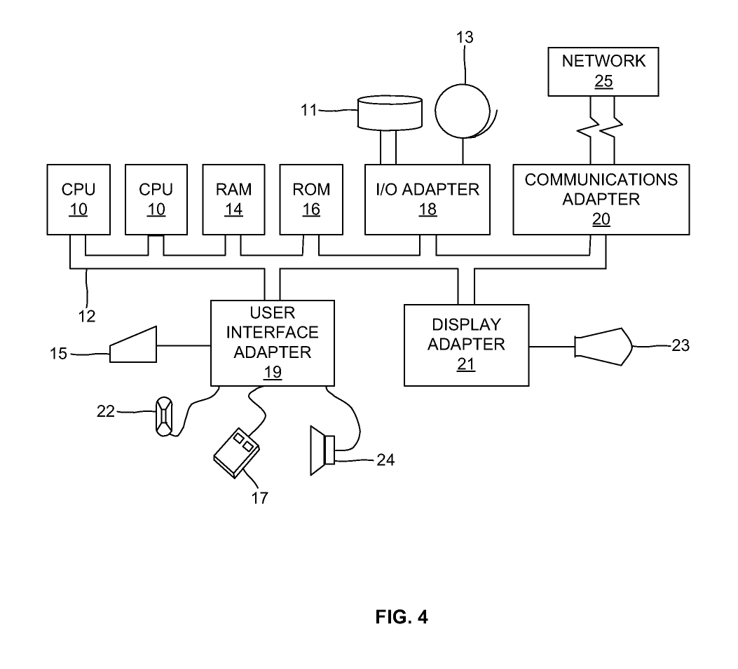

A representative hardware environment for practicing the embodiments herein is depicted in FIG. 4. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. An automatic vulnerability assessment system to assess vulnerability of a web service, comprising:
a memory unit that stores a set of modules and instructions; and
a processor which when configured by said instructions executes said set of modules, wherein said set of modules comprises:
an emulating module, executed by said processor, that is configured to run said web service with (a) a first credential to obtain a first set of parameters, and (b) a second credential to obtain a second set of parameters, wherein said first set of parameters comprises (i) a first session identifying parameters, (ii) a first request, and, (iii) a first response, wherein said second set of parameters comprises (i) a second session identifying parameters, (ii) a second request, and, (iii) a second response;
a first database, stored in said memory, that stores (i) said first session identifying parameters, (ii) said first request, and, (iii) said first response;
a second database, stored in said memory, that stores (i) said second session identifying parameters, (ii) said second request, and (iii) said second response;
a tampering module, executed by said processor, that is configured to receive (a) said first request from said first database, and (b) said second request from said second database, wherein said tampering module tampers a plurality of parameters of said first request with parameter values of said second request to obtain a third response; and
a response analysis module, executed by said processor, that is configured to receive (a) said third response from said tampering module, (b) said first response from said first database, and (c) said second response from said second database, wherein said response analysis module assesses vulnerability of said web service by comparing said third response with said second response.

2. The system of claim 1, wherein said response analysis module determines that there is a vulnerability of high severity of said web service when said third response comprises a part of said second response.

3. The system of claim 1, wherein said response analysis module determines that there is a vulnerability of medium severity of said web service when said third response is not an error, wherein said vulnerability of high severity of said web service is higher than said vulnerability of said medium severity of said web services.

4. The system of claim 1, wherein said tampering module tampers said plurality of parameters of said second request with parameter values of said first request to obtain a fourth response.

5. The system of claim 4, wherein said response analysis module assesses a vulnerability of said web service by comparing said fourth response with said first response, wherein said response analysis module determines that there is a vulnerability of high severity of said web service when said fourth response comprises a part of said first response, severity of said web service when said fourth response is not an error.

6. A processor implemented method of automatically assessing vulnerability of a web service, said method comprising
running a web service with (a) a first credential to obtain a first set of parameters, and (b) a second credential to obtain a second set of parameters, wherein said first set of parameters comprise (i) a first session identifying parameters, (ii) a first request, and, (iii) a first response, wherein said second set of parameters comprise (i) a second session identifying parameters, (ii) a second request, and, (iii) a second response;
storing (i) said first session identifying parameters, (ii) said first request, and, (iii) said first response;
storing (i) said second session identifying parameters, (ii) said second request, and (iii) said second response;
receiving (a) said first request from said first database, and (b) said second request from said second database;
tampering a plurality of parameters of said first request with parameter values of said second request to obtain a third response;
receiving (a) said third response from said tampering module, (b) said first response from said first database, and (c) said second response from said second database;
comparing said third response with said second response to assess vulnerability of said web service;
determining that there is a vulnerability of high severity of said web service when said third response comprises a part of said second response; and
determining that there is a vulnerability of medium severity of said web service when said third response is not an error, wherein said vulnerability of high severity of said web service is higher than said vulnerability of said medium severity of said web services.

7. The method of claim 6, further comprises tampering a plurality of parameters of said second request with parameter values of said first request to obtain a fourth response;
assessing vulnerability of said web service by comparing said fourth response with said first response;
determining vulnerability of high severity of said web service when said fourth response comprises a part of said first response; and
determining vulnerability of medium severity of said web service when said fourth response is not an error, wherein said vulnerability of high severity of said web service is higher than said vulnerability of said medium severity of said web services.

8. One or more non-transitory computer readable storage mediums storing one or more sequences of instructions, which when executed by one or more processors, causes automatically assessing vulnerability of a web service, by performing the steps of:
running a web service with (a) a first credential to obtain first parameters, and (b) a second credential to obtain second parameters, wherein said first parameters comprise (i) a first session identifying parameters, (ii) a first request, and, (iii) a first response, wherein said second parameters comprise (i) a second session identifying parameters, (ii) a second request, and, (iii) a second response;
storing (i) said first session identifying parameters, (ii) said first request, and, (iii) said first response;
storing (i) said second session identifying parameters, (ii) said second request, and (iii) said second response;
receiving (a) said first request from said first database, and (b) said second request from said second database;
tampering a plurality of parameters of said first request with parameter values of said second request to obtain a third response;
receiving (a) said third response from said tampering module, (b) said first response from said first database, and (c) said second response from said second database;
comparing said third response with said second response to assess vulnerability of said web service; and
determining that there is a vulnerability of high severity of said web service when said third response comprises a part of said second response.
determining that there is a vulnerability of medium severity of said web service when said third response is not an error, wherein said vulnerability of high severity of said web service is higher than said vulnerability of said medium severity of said web services.

9. The one or more non-transitory computer readable storage mediums storing one or more sequences of instructions of claim 8, further comprises:
tampering a plurality of parameters of said second request with parameter values of said first request to obtain a fourth response;
assessing vulnerability of said web service by comparing said fourth response with said first response;
determining that there is a vulnerability of high severity of said web service when said fourth response comprises a part of said first response; and
determining that there is a vulnerability of medium severity of said web service when said fourth response is not an error, wherein said vulnerability of high severity of said web service is higher than said vulnerability of said medium severity of said web services.
